(19) United States
(12) Patent Application Publication
(10) Pub. No.: US 2023/0217856 A1
(43) Pub. Date: Jul. 13, 2023

(54) MECHANICAL SHEARING AND HARVESTING TOOL

(71) Applicant: THOMAS V. RODEN, PORT WASHINGTON, WI (US)

(72) Inventor: THOMAS V. RODEN, PORT WASHINGTON, WI (US)

(21) Appl. No.: 18/094,448

(22) Filed: Jan. 9, 2023

Related U.S. Application Data
(60) Provisional application No. 63/298,704, filed on Jan. 12, 2022.

(51) Int. Cl. A01D 34/83

(52) U.S. Cl. CPC A01D 34/833

(57) ABSTRACT

The invention comprising a counter-rotating cutting device used for harvesting plant material in a field setting. Said cutting device having two overlayed cutting elements. Said device being attachable to a moving tractor device. The invention further providing individual shears attachable to each of said two cutting elements wherein each individual shear protrudes outward and capable of flexibly bending upward and downward in along the vertical plane.

### CROSS REFERENCE TO RELATED APPLICATIONS

This is a nonprovisional patent application claiming priority benefit of U.S. Provisional Patent Application No. 63/298,704, filed on Jan. 12, 2022, in accordance with 35 U.S.C. 119(e). Provisional patent application No. 63/298,704 is hereby incorporated by reference in its entirety.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

### Field of the Invention

The invention herein pertaining to a harvesting too, specifically counter-rotating shears, for harvesting or cutting plant material.

### Background

The invention disclosed herein pertains to a harvesting device, in particular a counter-rotating shearing device attachable to a moving tractor which shears plants along the ground surface as it passes. Prior art in this realm discloses harvesting tools attachable to large tractor vehicles that typically attach to either the front or rear of the vehicle. In those instances, the cutting feature is typically a unitary piece with many protruding shearing elements interconnected. Often, when traveling through an open field, materials will become caught between a shearing element and any adjacent surface, which causes a large portion of the unitary cutting feature or the entire piece to become stuck in a lifted position, rendering it inoperable until the operator removes the debris. Another issue of the unitary cutting feature of existing devices is that it is unable to move or adjust with the contour of the ground surface. As such, without the ability to accommodate the ground surface, it will experience the fullest effect of the contrary force of the uneven surface below it, causing an updraft of force against the device as it is being pulled forward. The updraft will cause the entire device to lift over portions of the ground surface for extended period, resulting in an uneven harvesting.

### SUMMARY AND DESCRIPTION OF INVENTION

The device of this invention improves upon existing technology by its unique design, improving operation and functionality in challenging environments. The invention herein resolves the above described two common issues among current harvesting and shearing designs by providing for a device that contains two cutting elements, each single cutting element of said two cutting elements comprising a circular belt element holding a plurality of shearing elements. Each said single cutting element positioned above and below each other along a horizontal plane and able to move in counter-rotation of each other. Each cutting element is positioned in parallel with each other in a top and bottom position over and under the other. Each shearing element of said plurality of shearing elements is removably attachable to a circular belt element. Each said circular belt element is preferably a closed loop circular shape with an external perimeter defined by the circular belt and a hollow open space internally beyond the circular belt element. The belt element of each said circular belt having an external surface facing the external environment and an internal surface facing centrally inward. The belt elements of each said single cutting element may comprise a plurality of interlinked metal chain elements. Alternatively, each said circular belt element may comprise a singular unitary piece of durable flexible and nonbrittle material that is able to receive and hold in position each said shearing elements in removably connectable manner while moving in counter-rotation of each other around rotating gear elements positioned at two opposing ends along said horizontal plane. Each said shearing element of said plurality of shearing elements is removably attachable to each said circular belt element and are spaced apart from each other by a certain distance to allow a gap space there between for debris to fall through.

Each said circular belt element of each said cutting element is held within a platform. Said platform comprising an open frame element and a guide element. Said open frame element having a geometric shape where the perimeter is defined by a solid frame. Said solid frame comprising solid, durable, heavy material such as metal, wood, or plastic or a combination of these elements. The space internal to said solid frame is open (herein referred to as the “internal frame space”) such that each shearing element of each single cutting element would have access to the internal frame space. The purpose of the internal frame space is to allow harvested or cut field material to pass over and through said internal frame space. By positioning each shearing element adjacent to said internal frame space, each shearing element would have access to said internal frame space. Therefore, the width of said internal frame space as defined by the geometric shape of said frame element is equal to or greater than the width of each said cutting element in its extended form when attached to rotating gear elements. Each single cutting element may be held entirely within the internal frame space of said frame element where harvested material would pass through the internal frame space or any open space within the frame element or any space between the frame element and said two cutting elements. Alternatively, each single cutting element may be positioned halfway between the internal frame space and half way external beyond the perimeter of said open frame element along the portion of its width such that the shearing elements protrude beyond the perimeter of said open frame element. For improved safety, positioning each single cutting element entirely within the internal frame space would allow said solid frame to serve as a guard that prevents users from direct contact with said plurality of shearing elements.

Said guide element of said platform comprising two guide plates. Each guide plate of said two guide plates may be positioned above and below said cutting element wherein said top single cutting element and bottom single cutting element is positioned therebetween. A narrow space exists between said two guide plates to accommodate fluid uninterrupted movements of said two cutting elements and their each shearing elements held therebetween. Said guide plate provides structural wall support to prevent each shearing element from pivoting vertically upward or downward too far or be in the pivoted position for too long. Each said guide plate also comprising a geometric shape and is a continuous piece of solid durable smooth material that is further slick or slippery in nature such that debris or harvested material will not adhere to it but rather, pass over or through smoothly. Each said guide plate is narrow in dimension at its each said length and wider along its width such that it extends overtop a portion of each shearing element at their each point of attachment to said circular belt element while leaving the internal frame space open. Said guide element is intended to provide structural support and guide fluid traversal of said shearing elements during usage. More than one set of two single guide plates may be attached to said platform. According to one embodiment, one set of two single guide plates as described above may positioned over the proximal width of said cutting element. The proximal width of said cutting element comprising the side of said cutting element closest to the vehicle that it is attached to and the distal width comprising its opposing side. According to another embodiment, one set of two single guide plates as described above is positioned over the proximal width and another set is positioned over the distal width of said cutting element wherein the internal frame space remains open to allow material to pass therethrough.

Each said shearing element is attached to the external edge of each said circular belt element such that a plurality of shearing elements radiate outward away from the center of each said rotating belt elements and along the same horizontal plane as each said circular belt. Each said shearing element extending outward away from the external edge of each said circular belt element at a relative angle of between 35 degrees to 90 while horizontally disposed.

Each said shearing element having the ability to pivot in an upward or downward direction relative to the horizontal plane of each said circular belt element when encountering obstructive objects during use. The ability to pivot is enabled by a spring coil feature located at its proximal end. Said proximal end of each said shearing element is the location where it is attached to said circular belt element. Each said shearing element being removably attachable to said circular belt element. Each said shearing element when attached to each said circular belt element is held in durable secure manner such that sufficient tension exists along the length of each said shearing element to avoid pivoting during use unless engaged with hard material such as rocks or excess immovable or lodged material. Each said shearing element may comprise round or flattened blades or tines that extends outward at an angular manner from the external edge of each said rotating belt element. Each said shearing element of said top and bottom circular belt element faces each other when passing each other in counter-rotating manner to cause a shearing effect and cut of the harvested material similar to a scissor style cut. The lack of actual physical connection between the top and bottom positioned shearing elements enable them each to move independently of each other in a vertical direction to facilitate dislodging of stuck material. The spring coil tension of each said shearing elements attached to each said top and bottom positioned circular belt element of said cutting element is directed towards the center such that the tine elements of the top and bottom circular belt elements are always motivated towards the center and towards each other.

Each shearing element comprising a spring coil feature on its first proximal end and a tine element on its second distal end. Said first end being removably connectable to the external edge of each said circular belt elements by a connecting element. Said connecting element may comprise a pin or bolt style connection between each said shearing element and said rotating belt elements to hold said shearing element durably and stability in place. Each said shearing element may flexibly bend in a pivoting manner vertically upward or downward by its spring coil feature. The device provides for an improved and enhanced performance whereby any obstructed portion of the device will not stop the entire operation of the device. The counter-rotating belts will continue to be able to rotate despite any obstructions. Obstructed areas will be localized without effecting the ability of other portions of the device to continue shearing. The device is able to self-correct by independently dislodging stuck material as the belts continue to rotate and the shearing elements are able to pivot. Any caught debris may be released through the gap space between each shearing element and the open space central to each circular belt elements and the frame element. The device may self-correct while the machine is operation and thus, minimize the need to interrupt work flow.

Another embodiment of the shearing element may comprise two detachable parts centrally connectable by a spring loaded pin element. The spring loaded feature of said spring loaded pin element provides a similar flexibility and ability to vertically pivot as the spring coil feature of the first embodiment described above. The location of pivot by this alternative embodiment is located further away from the proximal end of each said shearing element. By this embodiment, the proximal end of each said shearing element will lack a spring coil and will be permanently attached to the external edge of each said belt element. The location of disconnection for replacement purposes in this case is distally further away. The intended benefit of moving the pin connection and spring element further away from the proximal end of each said shearing element is to enable easier access to the user when replacement of parts is required. The connection being located further distally outward is within easier reach by the user. Ease of access and replacement will also reduce the amount of time expended on fixing or replacing damaged parts while the device is in use in the field. This method also reduces material content and cost for replacement parts.

Yet another alternative embodiment of the shearing element is similar to the above described first embodiment wherein the shear element comprising a spring coil feature on its proximal end and a tine element towards its distal end. Said shearing element is attachable to said circular belt element at its proximal end closest to the spring coil element. However, according to this alternative embodiment, a second connection point exists beyond the proximal end between the spring coil element and the tine element. A secure connection point here enables secure removable connection and detachment of the tine element from said shearing element for easier reach and quicker replacement of parts while maintaining the integrity of the spring effect closer to the proximal end for greater leverage effect on the pivot action. In this case, the secure connection point may be held together by a pin, screw, or bolt connection or any combinations thereof.

Each circular belt elements of said cutting element of this invention comprising an oval shape when extended and looped around gear elements positioned at a right and left end along a horizontal plane. Each of said two circular belt elements are removably attachable to said frame element in parallel manner. A rotatable motor driven gear element is attached at either left or right end or at both left and right ends of said frame element. Said counter-rotating spin of each said circular belt element is driven by at least one or more motor driven gear element removably connected to each said top and bottom circular belt element and rotatable in opposing directions. If each circular belt element of said top and bottom circular belt element of said cutting element is driven by only a single motor driven gear element, then said motor driven gear element would be positioned at a right or left end and a rotatable spool element would be positioned at the opposing end such that said belt element is wrapped around both for proper extension and rotation. If two or more motor driven gear elements are required for any single top or bottom circular belt element, then a single motor driven gear element is positioned to the left and another the right end of both said circular belt element. Said top and bottom circular belt elements are wrapped around said left and right side single motor driven gear elements.

Said device of this invention is operable by an external electrical switch that operates a hydraulic valve. Alternatively, the switch may be located inside the vehicle that is attached to said hydraulic valve. Said hydraulic valve is connected to a hydraulic motor. Said hydraulic motor is preferably capable of moving said gear elements at 2500 rpm in either directions wherein the speed of cutting action may be at a speed of up to 5000 rmp such that the vehicle may drive faster while cutting.

The device of this invention is attachable to the suspension system described within U.S. Pat. Nos. 4,747,255, 4,907,400, 4,972,661. The suspension system of the above referenced patents ('255, '400, '661) would minimize damage to the cutting bar element of this invention by allowing the entire cutting bar to lift vertically by a suspension feature when traversing uneven ground. This is achieved by attaching the suspension system to the cutting bar on either left and right sides of said cutting bar in a pivoting manner. Eight bars extend from said suspension system (which is attached to the moving vehicle) to said cutting bar with four bars on each left and right sides of said cutting bar. The eight bars pivot at their location of connection between said cutting bar and suspension system, allowing flexible guided movement of said cutting bar within a vertical range. Application of the cutting bar element of this invention with the above-described suspension system further reduces an updraft effect when traversing uneven ground according to its wider and flatter shape and its ability for uninterrupted cutting.

Other features, advantages, and object of the present invention will become more apparent and be more readily understood from the following detailed description, which should be read in conjunction with the accompanying drawings.

### DESCRIPTION OF DRAWINGS

FIG. 1 provides illustration of a top front perspective view of the invention according to a preferred embodiment.

FIG. 2 provides illustration of a top plan view of the invention according to a preferred embodiment.

FIG. 3 provides illustration of a top plan view of the invention according to a preferred embodiment.

FIG. 4 provides an illustration of a top plan view of the invention according to a preferred embodiment.

### DETAILED DESCRIPTION OF DRAWINGS

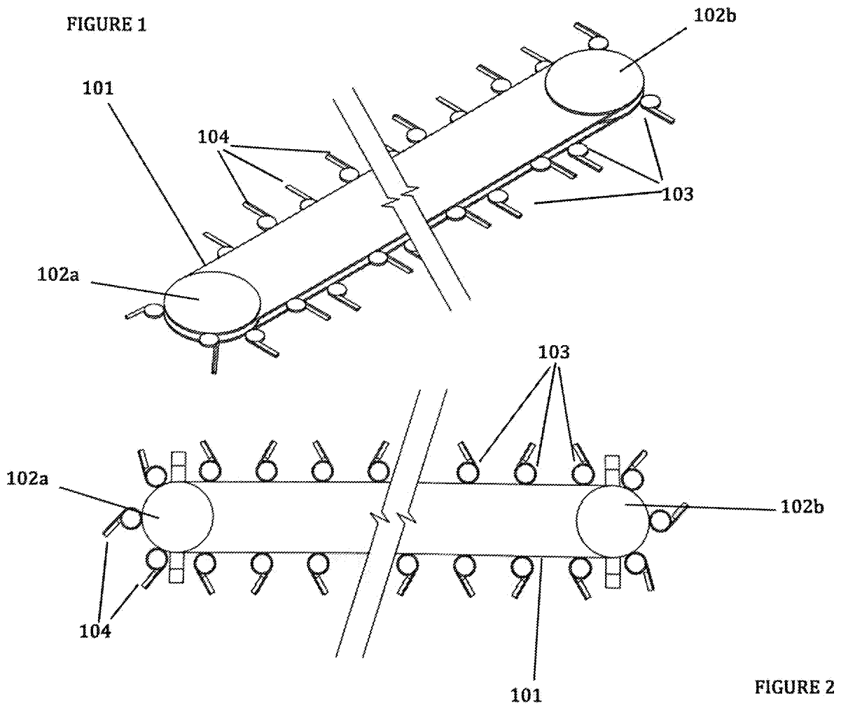

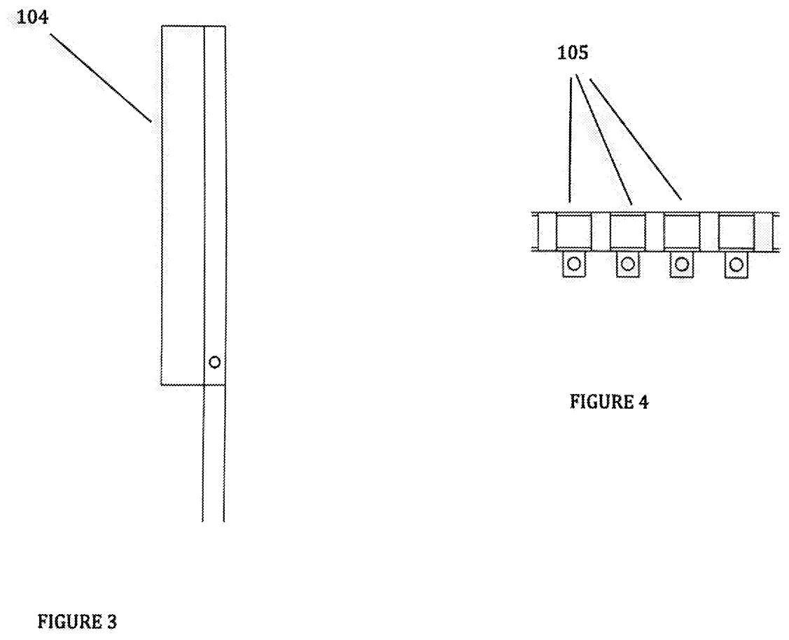

FIG. 1 provides illustration of a top front perspective view of the invention according to a preferred embodiment. According to FIG. 1, a single circular belt 101 is portrayed wherein said circular belt 101 comprising an oval shape when extended and looped around gear elements 102a, b positioned at a right and left end along a horizontal plane. Said single circular belt 101 is removably attachable to a plurality of shearing elements 103 wherein the blade or tine portion 104 of the shearing element 103 extends outward from said circular belt 101. Each said shearing element 103 may comprise round or flattened blades or tines 104 that extends outward at an angular manner from the external edge of each said circular belt 101 element. FIG. 3 provides illustration of an embodiment of the shearing element 103 comprising a flattened blade or tine 104. The belt elements 101 of each said single cutting element may comprise a plurality of interlinked metal chain elements 105, as shown in part by FIG. 4.

FIG. 2 provides further illustration of a top plan view of the invention where two circular belts 101 are overlayed on top of each other, attached to one or more motor driven gear elements 102a,b. Optionally, said two circular belts 101 are overlayed on top of each other, attached to one or more motor driven gear elements 102a,b and at least one rotatable spool element 102a,b. The angular protrusion of the shearing elements 103 of the top positioned circular belt 101 is pointed in an opposite direction of the shearing elements 103 protruding from the bottom circular belt 101. The shearing elements 103 of the top and bottom circular belts 102 are pointing in an angular direction towards each other such that the sharp tines 104 cross each other creating a shearing effect on material passing therethrough.

Each of said two circular belt elements 101 are removably attachable to said frame element 107 in parallel manner. A rotatable motor driven gear elements 102a,b are attached at either left or right end or at both left and right ends of said frame element 107. Said counter-rotating spin of each said circular belt element 101 is driven by at least one or more motor driven gear element 102a,b removably connected to each said top and bottom circular belt element 101 and rotatable in opposing directions. If each circular belt element 101 of said top and bottom circular belt element is driven by only a single motor driven gear element, then said motor driven gear element would be positioned at a right or left end and a rotatable spool element would be positioned at the opposing end such that said belt element is wrapped around both for proper extension and rotation. If two or more motor driven gear elements are required for any single top or bottom circular belt element, then a single motor driven gear element is positioned to the left and another the right end of both said circular belt element. Said top and bottom circular belt elements are wrapped around said left and right side single motor driven gear elements.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

1. A mechanical shearing and harvesting tool comprising
two individual cutting elements,
each individual cutting element of said two individual cutting elements comprising a circular belt element holding a plurality of shearing elements
each said individual cutting element positioned above and below each other along a horizontal plane and able to move in counter-rotation of each other,
each individual cutting element is positioned in parallel with the other in a top and bottom position over and under the other,
each individual cutting element comprising a circular belt element,
each said circular belt element is preferably a closed loop circular shape with an external perimeter defined by the circular belt and a hollow open space internally beyond the circular belt element,
the belt element of each said circular belt having an external surface facing the external environment and an internal surface facing centrally inward,
the belt elements of each said single cutting element may comprise a plurality of interlinked metal chain elements.

2. Each said shearing element of said plurality of shearing elements is removably attachable to each said circular belt element and are spaced apart from each other by a certain distance to allow a gap space therebetween.
